(19) United States
(12) Patent Application Publication
(10) Pub. No.: US 2022/0309381 A1
(43) Pub. Date: Sep. 29, 2022

(54) VERIFICATION OF DATA REMOVAL FROM MACHINE LEARNING MODELS

(71) Applicant: International Business Machines Corporation, Armonk, NY (US)

(72) Inventors: Abigail GOLDSTEEN, Haifa (IL); Ron SHMELKIN, Haifa (IL)

(21) Appl. No.: 17/209,751

(22) Filed: Mar. 23, 2021

(51) Int. Cl. G06N 20/00; G06K 9/62

(52) U.S. Cl. CPC G06N 20/00; G06K 9/6215; G06K 9/6202; G06K 9/6262

(57) ABSTRACT

An example system includes a processor to receive one or more target data samples from a training set used to train a machine learning model, a training data sample including a different data sample from the training set, and a forgotten model including the machine learning model with a forgetting mechanism applied on the target data sample. The processor can calculate a model uncertainty or a model similarity based on the forgotten model, the target data sample, and the training data sample. The processor can verify a removal of the target data sample from the forgotten model based on the model similarity or the model uncertainty.

### BACKGROUND

The present techniques relate to data removal verification. More specifically, the techniques relate to data removal verification for machine learning models.

Data may be removed from a database in response to receiving a request to forget the data. However, machine learning models trained using the forgotten data may still be used to retrieve the data via attacks, such as inference attacks. Several recent works have proposed various methods to remove user data from a machine learning (ML) model. Existing methods that evaluate how well such a removal process functions include determining error rates, information bounds, prediction entropy, gradient residual norm, loss, and even retrain time on the forgotten samples. The use of different methods makes it very difficult to compare between removal methods. In addition, such methods sometimes make assumptions about how the forgetting was performed. In addition, assumptions made on the data and model by such methods may not always hold. Finally, such methods may incur a very large computing overhead.

### SUMMARY

According to an embodiment described herein, a system can include processor to receive one or more target data samples from a training set used to train a machine learning model, a training data sample including at least one different data sample from the training set, and a forgotten model including the machine learning model with a forgetting mechanism applied on the target data sample. The processor can also further calculate a model uncertainty or a model similarity based on the forgotten model, the target data sample, and the training data sample. The processor can also verify a removal of the target data sample from the forgotten model based on the model similarity or the model uncertainty. Optionally, to calculate the model similarity, the processor is to train a first set of models on the training data samples and the target data sample and a second set of models on the training data samples without the target data sample, and compute a similarity between the forgotten model and the first set of models to generate a first distribution of similarity scores, and a similarity between the forgotten model and the second set of models to generate a second distribution of similarity scores. In this embodiment, the use of two sets of models may enable a distribution comparison. Optionally, to verify the removal of the target data sample based on the model similarity, the processor is to perform a comparison between the first distribution of similarity scores and the second distribution of similarity scores, and verify that the removal of the target data sample succeeded in response to detecting that a difference of distributions between the first distribution of similarity scores and the second distribution of similarity scores exceeds a threshold. In this embodiment, the use of two sets of models may enable the distribution comparison. Optionally, to verify the removal of the target data sample based on the model similarity, the processor is to compute a similarity between the first set of models and the second set of models to generate a third distribution of similarity scores, and a similarity between the second set of models to generate a fourth distribution of similarity scores, and verify that the removal of the target data sample succeeded in response to detecting that a difference of distributions calculated between the second distribution and the fourth distribution is less than a difference of distributions calculated between the second distribution and the third distribution, or in response to detecting that a difference of distributions calculated between the first distribution and the fourth distribution is greater than a difference of distributions calculated between the first distribution and the third distribution. In this embodiment, a benefit of using the third and fourth distributions is that a threshold may not be needed in advance because the comparison is relative. Optionally, to calculate the model similarity, the processor is to train a set of models on the training data sample without the target data sample and compute a first distribution of similarity scores between the forgotten model and a set of retrained models, and a second distribution of similarity scores between the set of retrained models, and verify that the removal of the target data sample succeeded in response to detecting that a difference of distributions calculated between the first distribution of similarity scores and the second distribution of similarity scores does not exceed a threshold. In this embodiment, less models may be trained and thus resources saved. Optionally, to calculate the model uncertainty, the processor is to calculate an uncertainty of the forgotten model with respect to the target data sample to be forgotten and an uncertainty of a retrained model trained with the target data sample absent from the training set used to train the forgotten model with respect to the target data sample to be forgotten, wherein the processor is to verify that the removal of the target data sample succeeded in response to detecting that the uncertainty of the forgotten model is similar to the uncertainty of the retrained model. In this embodiment, the confidence of the verification may be higher because the same sample is used. Optionally, to calculate the model uncertainty, the processor is to calculate an uncertainty of the forgotten model with respect to the target data sample to be forgotten and a sample known to be absent from the training set used to train the forgotten model, wherein the processor is to verify that the removal of the target data sample succeeded in response to detecting that the uncertainty of the target data sample is similar to the uncertainty of the sample known to be absent. In this embodiment, resources may be saved by not retraining the machine learning model. Optionally, to calculate the model uncertainty, the processor is to calculate an uncertainty of the forgotten model with respect to the target data sample to be forgotten and compare the calculated uncertainty to an uncertainty threshold, wherein the uncertainty threshold is calculated based on an uncertainty of a retrained model trained with the target data sample absent from the training set with respect to the target data sample, and an uncertainty of the machine learning model with respect to the target data sample to be forgotten. In this embodiment, a more accurate result from the uncertainty may be achieved because more information is taken into account, and more flexibility is provided to determine the threshold by considering both the original model and the retrained model.

According to another embodiment described herein, a method can include receiving, via a processor, a machine learning model, a forgotten model, and a target data sample. The method can further include calculating, via the processor, a model uncertainty or a model similarity based on the machine learning model, the forgotten model, and the target data sample. The method can also further include verifying, via the processor, a removal of the target data sample from the forgotten model based on the model similarity or the model uncertainty. Optionally, calculating the model similarity includes training two sets of models using a same architecture and hyperparameters as the machine learning model, wherein a first set of models is trained on a training set including the target data sample and the second set of models is trained on the training set without the target data sample. In this embodiment, the use of two sets of models may enable a distribution comparison. Optionally, calculating the model similarity includes calculating a pairwise similarity between all models in the second set of models. In this embodiment, the comparison of models may enable an additional distribution comparison. Optionally, calculating the model similarity includes calculating a pairwise similarity between each model in the first set of models and the second set of models. In this embodiment, the pairwise comparison of models may enable an additional distribution comparison. Optionally, calculating the model similarity includes calculating a pairwise similarity between the forgotten model and the first set of models, and a pairwise similarity between the forgotten model and the second set of models. In this embodiment, the pairwise comparison of models may enable an additional distribution comparison. Optionally, calculating the model uncertainty includes calculating an uncertainty of the forgotten model with respect to the target data sample and an uncertainty of a retrained model with respect to the target data sample. In this embodiment, the machine learning model may not have to be provided for the verification. Optionally, calculating the model uncertainty includes calculating an uncertainty of the forgotten model with respect to the target data sample and an uncertainty of the forgotten model with respect to a data sample that is known to be excluded from training the forgotten model. In this embodiment, resources may be saved by not retraining a retrained model. Optionally, the method can further include executing a sanity check using a comparison to a result of forgetting a different data sample. In this embodiment, the sanity check may prevent incorrect verification due to unintended side effects of the forgetting process.

According to another embodiment described herein, a computer program product for data removal verification can include computer-readable storage medium having program code embodied therewith. The computer readable storage medium is not a transitory signal per se. The program code executable by a processor to cause the processor to receive a machine learning model, a forgotten model, and a target data sample. The program code can also cause the processor to calculate a model uncertainty or a model similarity based on the machine learning model, the forgotten model, and the target data sample. The program code can also cause the processor to verify removal of the target data sample from the forgotten model based on the model similarity or the model uncertainty. Optionally, the program code can also cause the processor to train two sets of models using a same architecture and hyperparameters as the machine learning model, wherein a first set of models is trained on a training set including the target data sample and the second set of models is trained on the training set without the target data sample. In this embodiment, the use of two sets of models may enable a distribution comparison. Optionally, the program code can also cause the processor to calculate a pairwise similarity between all models in the second set of models. In this embodiment, the pairwise comparison of models may enable an additional distribution comparison. Optionally, the program code can also cause the processor to also further calculate a pairwise similarity between each model in the first set of models and the second set of models. In this embodiment, the pairwise comparison of models may enable an additional distribution comparison. Optionally, the program code can also cause the processor to also calculate a pairwise similarity between the forgotten model and the first set of models, and a pairwise similarity between the forgotten model and the second set of models. In this embodiment, the pairwise comparison of models may enable an additional distribution comparison.

### BRIEF DESCRIPTION OF THE SEVERAL VIEWS OF THE DRAWINGS

FIG. 1 is a block diagram of an example system for verifying data removal in machine learning models;

FIG. 2 is a block diagram of an example system for verifying data removal in machine learning models using similarity;

FIG. 3 is a block diagram of an example system that can perform model similarity comparisons to verify data removal in machine learning models;

FIG. 4 is a block diagram of an example system for verifying data removal in machine learning models using model uncertainty;

FIG. 5 is a block diagram of an example method that can verify data removal in machine learning models;

FIG. 6 is a block diagram of an example method that can verify data removal in machine learning models using model similarity;

FIG. 7 is a block diagram of an example method that can verify data removal in machine learning models using model uncertainty;

FIG. 8 is a block diagram of an example computing device that can verify data removal in machine learning models;

FIG. 9 is a diagram of an example cloud computing environment according to embodiments described herein;

FIG. 10 is a diagram of an example abstraction model layers according to embodiments described herein; and

FIG. 11 is an example tangible, non-transitory computer-readable medium that can verify data removal in machine learning models.

### DETAILED DESCRIPTION

According to embodiments of the present disclosure, system includes a processor to receive one or more target data samples from a training set used to train a machine learning model, a training data sample including at least one different data sample from the training set, and a forgotten model including the machine learning model with a forgetting mechanism applied on target data sample. The processor can calculate a model uncertainty or a model similarity based on the forgotten model, the one or more target data samples, and the training data sample. The processor can verify a removal of the target data sample from the forgotten model based on the model similarity or the model uncertainty. Thus, embodiments of the present disclosure allow verification of data sample removals from machine learning models. Moreover, the embodiments can be applied to previously trained models, such as previously trained neural network models. The embodiments therefore do not require any changes to the training process with respect to such models. The forgetting process itself is assumed to be a black-box, and the techniques therefore work with any forgetting process. Moreover, the forgetting process is not required nor assumed to retrain models or even have access to the original training data. In addition, the embodiments may also be applied to various types of models, such as convolutional neural network (CNN) models, recurrent neural network (RNN) models, or a random forest search model, among other suitable machine learning models. In some examples, the embodiments may also be applied to models such as logistic regression models or state vector machines (SVMs). Finally, the techniques may be used periodically as a form of offline evaluation in order to save resources while ensuring that a forgetting mechanism is performing adequately. In some examples, the techniques may be run once to evaluate or compare between different forgetting methods and choose a forgetting method with better performance.

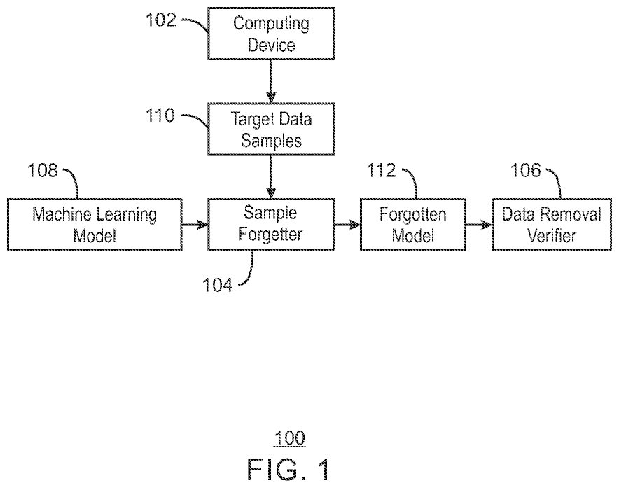

With reference now to FIG. 1, a block diagram shows an example system for verifying data removal in machine learning models. The example system 100 of FIG. 1 includes a computing device 102. The system 100 further includes a sample forgetter 104 communicatively coupled to the computing device 102. As used herein, coupled means that the elements may be directly connected together or may be connected through one or more intervening elements. The system 100 also further includes a data removal verifier 106 communicatively coupled to the sample forgetter 104. The sample forgetter 104 is shown receiving a machine learning model 108 and one or more target data samples 110 and outputting a forgotten model 112. For example, the machine learning model 108 may be a neural network, such as a convolutional neural network, a recurrent neural network, or deep neural network. In some examples, the machine learning model 108 may be a random forest search model, among other suitable machine learning models. The one or more target data samples 110 are shown being received by the sample forgetter 104 from the computing device 102. For example, the target data samples 110 may include a target data sample or multiple target data samples, or a target percentage of the training data, to be forgotten from the machine learning model 108. The system 100 also includes a forgotten model 112 shown being received by the data removal verifier 106 from the sample forgetter 104.

In the example of FIG. 1, the computing device 102 may be used to send one or more target data samples 110 to the sample forgetter 104. For example, the target data samples 110 may be data samples to be removed from a machine learning model 108. The sample forgetter 104 may remove the particular target data samples 110 from the machine learning model 108 using a forgetting process and output a forgotten model 112. In various examples, any suitable forgetting process may be used to remove the target data samples 110 from the machine learning model 108 without having to retrain the machine learning model 108 to generate the forgotten model 112. In some examples, the forgetting process used is stochastic. For example, the forgetting process can be run multiple times to yield slightly different results. As used herein, a forgotten model refers to an updated machine learning model having the request to be forgotten applied. For example, the forgotten model 112 may be the machine learning model 108 with a forgetting mechanism applied to forget one or more target data samples 110.

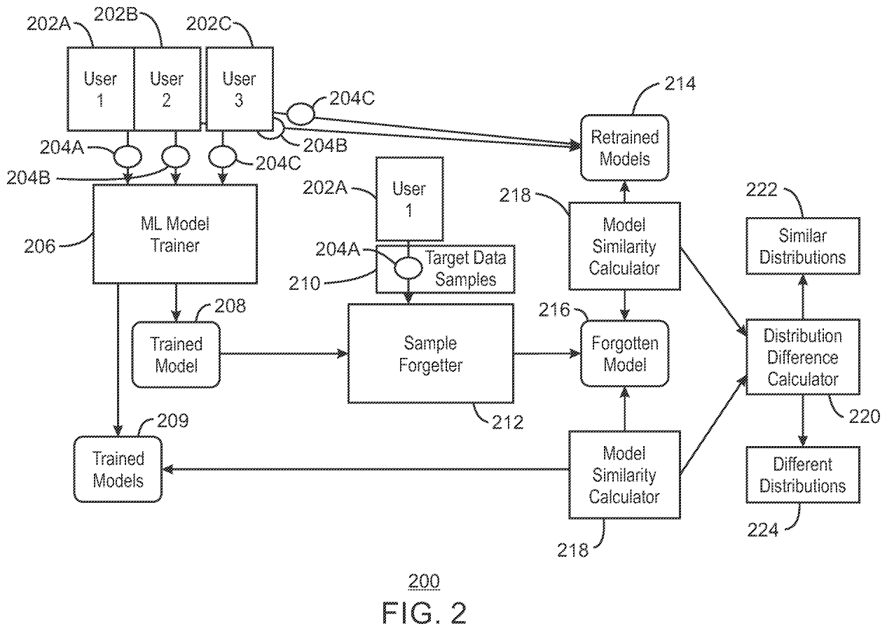

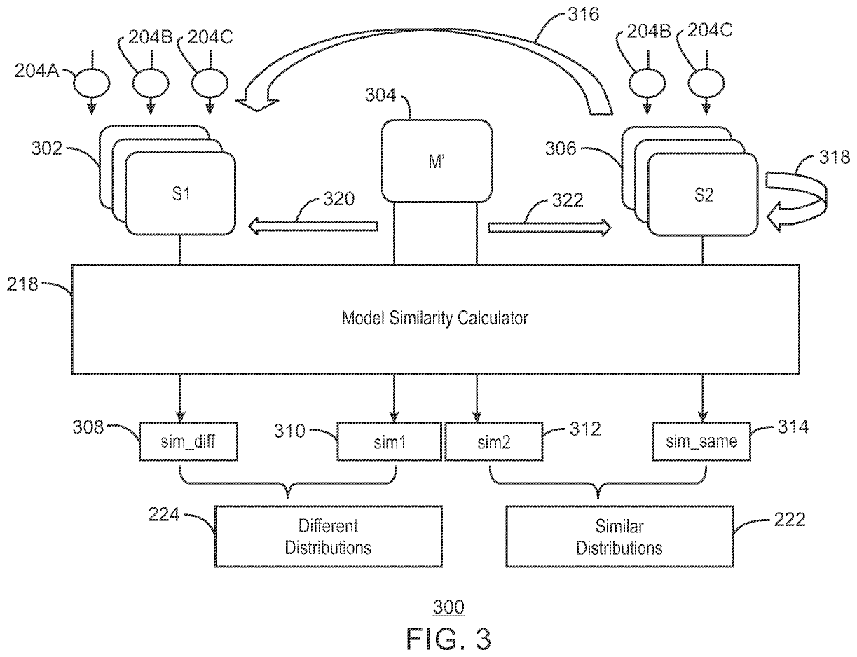

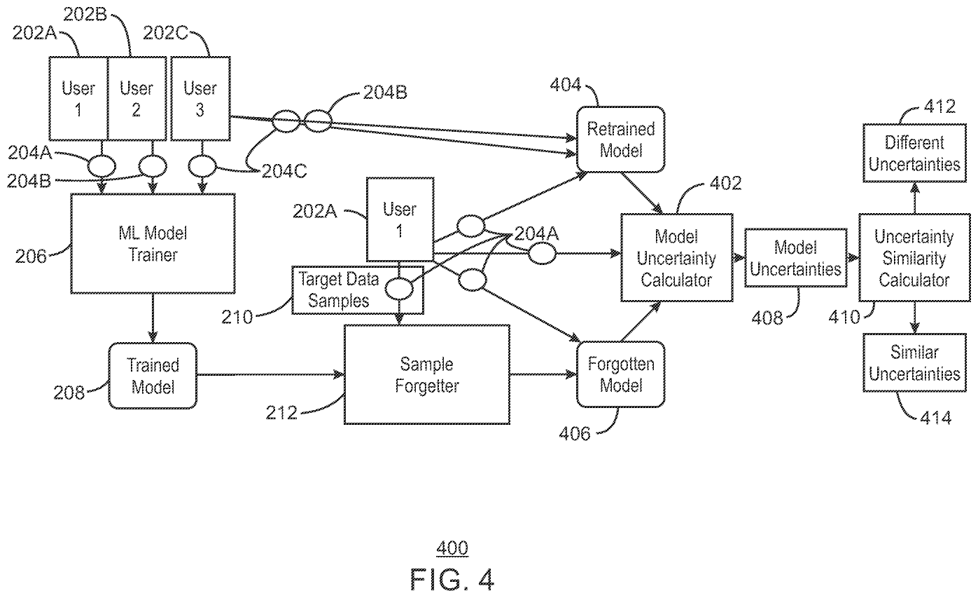

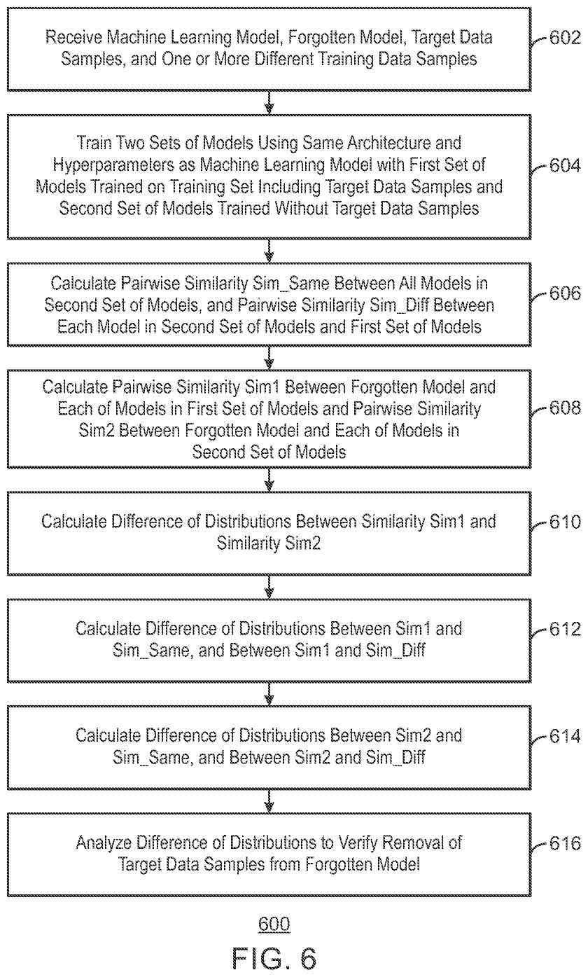

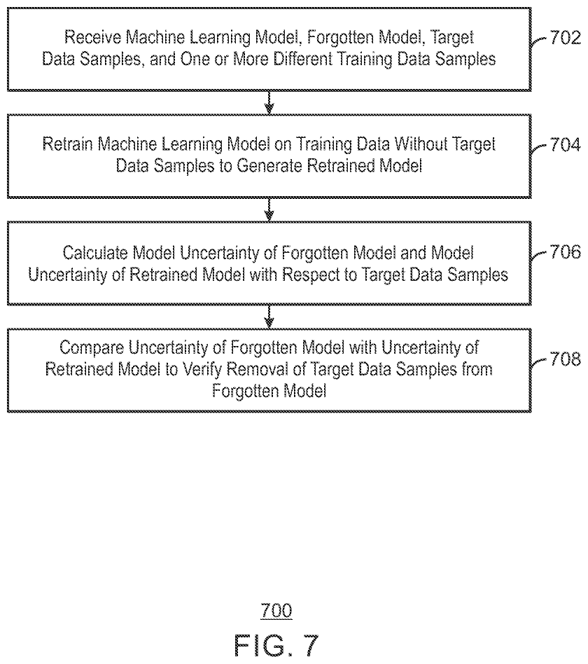

Still referring to FIG. 1, the data removal verifier 106 may verify the removal of the one or more target data samples 110 from the forgotten model 112. In various examples, the data removal verifier 106 may verify the removal of the data using model similarity. As used herein, model similarity refers to a set of techniques that compare between two or more machine learning models and assign the comparison a similarity score. The comparison used in the model similarity techniques may not be related to any privacy techniques or the right to be forgotten. In various examples, any suitable technique for comparing machine learning models may be used to generate the similarity score. Using any suitable technique, the model similarity may determine the similarity of the forgotten model 112 to other types of models. For example, the data removal verifier 106 may verify the removal via the systems 200 or 300 of FIG. 2 or 3, or using the method 600 of FIG. 6. In some examples, the data removal verifier 106 may verify the removal of the data using model uncertainty. For example, the data removal verifier 106 may verify the removal of the data using any suitable uncertainty measuring technique. In various examples, the uncertainty measuring technique may not be related privacy or the right to be forgotten. In various examples, the data removal verifier 106 may verify the removal of the data using the model uncertainty techniques of system 400 or the method 700, as described in FIGS. 4 and 7.

It is to be understood that the block diagram of FIG. 1 is not intended to indicate that the system 100 is to include all of the components shown in FIG. 1. Rather, the system 100 can include fewer or additional components not illustrated in FIG. 1 (e.g., additional computing devices, or additional target data samples, or machine learning models, etc.). For example, in some embodiments, an additional sanity check may be performed by comparing to the result of forgetting a different set of samples than the target sample or set of samples. The sanity check may show that the detected differences are not just a result of unintentional side effects from applying the forgetting process on the machine learning model 108. In some examples, the machine learning model 108 may be recited from the computing device 102 in addition to the target data samples 110.

FIG. 2 is a block diagram shows an example system for verifying data removal in machine learning models using similarity. The example system is generally referred to by the reference number 200. The example system 200 of FIG. 2 includes a first user 202A, a second user 202B, and a third user 202C. The system includes a first data 204A, a second data 204B, and a third data 204C, associated with the first user 202A, the second user 202B, and the third user 202C, respectively. The system 200 also includes a machine learning (ML) model trainer 206 shown receiving the first data 204A, the second data 204B, and the third data 204C from the first user 202A, the second user 202B, and the third user 202C. The system 200 includes trained model 208 and trained models 209, shown being generated by the ML model trainer 206. For example, the trained model 208 and trained models 209 are trained on data sample 204A, in addition to data samples 204B and 204C. In various examples, the trained model 208 may have been previously trained on the first data 204A, the second data 204B, and the third data 204C using any suitable training process. The trained models 209 may each be trained on the first data 204A, the second data 204B, and the third data 204C for use in the similarity methods described herein. The system 200 also includes target data samples 210 shown being received from the first user 204A and including the first data 204A. The system 200 also further includes a sample forgetter 212 communicatively coupled to the ML model trainer 206 and shown receiving the trained model 208 and the target data samples 210. The system 200 includes retrained models 214 shown trained on the second data 204B and the third data 204C from the second user 202B and the third user 202C, respectively. For example, the retrained models 214 may include the same hyperparameters and have the same architecture as the trained model 208. The system 200 also further includes a forgotten model 216 shown being generated by the sample forgetter 212. The system 200 also further includes a model similarity calculator 218 shown calculating a similarity between the forgotten model 216 and the retrained models 214, and between the forgotten model 216 and the trained models 209. Although shown twice for better visualization, the model similarity calculator 218 may be implemented as a single module that can perform similarity calculations, or multiple, separate, and dedicated model similarity calculators 218 that can process similarity calculations in parallel. The system 200 also includes distribution difference calculator 220 communicatively coupled to the model similarity calculators 218. The distribution difference calculator 220 is shown outputting a detection of similar distributions 222 and a detection of dissimilar distributions 224.

In the example of FIG. 2, a user 202A may submit target data samples 210 including data sample 204A. Preferably, the data sample 204A is a subset of the training data, including multiple data samples or a percentage of the training data. The sample forgetter 212 may generate a forgotten model 216 using any suitable forgetting technique to forget the target data sample 204A.

Still referring to FIG. 2, the model similarity calculator 218 can calculate similarities between the forgotten model 216 and the retrained models 214, and between the forgotten model 216 and the trained models 209. For example, the model similarity calculator 218 can calculate pairwise similarities between the forgotten model and each of the models in the retrained models 214 and the trained models 209. In various examples, the calculated pairwise similarities may collectively form distributions of similarity scores representing each comparison. For example, each distribution may be in the form of a vector of pairwise similarity scores. In some examples, the model similarity calculator 218 can calculate similarities as described in greater detail with respect to the system 300 of FIG. 3.

The distribution difference calculator 220 can then compare various distributions and determine whether they are similar distributions 222 or different distributions 224. In some examples, the determination may be made using a threshold, such as a threshold distance, between the distributions. For example, as shown in the example of FIG. 2, the distribution difference calculator 220 can compare the distribution of the similarities between the forgotten model 216 and the retrained models 214, and the distribution of the similarities between the forgotten model 216 and the trained models 209. In this example, if the distributions are determined to be similar distributions 222, then a failed forgetting of the target data samples 210 may be detected. Otherwise, if the distributions are determined to be dissimilar distributions 224, then a successful forgetting of the target data samples 210 may be detected.

It is to be understood that the block diagram of FIG. 2 is not intended to indicate that the system 200 is to include all of the components shown in FIG. 2. Rather, the system 200 can include fewer or additional components not illustrated in FIG. 2 (e.g., additional target data samples, or additional trained models, retrained models, or comparisons, etc.). In some examples, the model similarity calculator 218 can alternatively, or in addition, also calculate pairwise similarities between the retrained models 214. In various examples, model similarity calculator 218 can alternatively, or in addition, also calculate pairwise similarities between the retrained models 214 and the trained models 209. In these examples, the distribution difference calculator 220 can determine the similarity between distributions generated by the calculated pairwise similarities. For example, the distribution difference calculator 220 can then compare the distribution of the similarities between the forgotten model 216 and the retrained models 214 to these additional calculated distributions to determine if the target data samples 210 were successfully forgotten. In addition, the distribution difference calculator 220 can also compare the distribution of the similarities between the forgotten model 216 and the trained models 209 to determine if the target data samples 210 were successfully forgotten. For example, the distribution difference calculator 220 can compare these additional distributions as described in FIG. 3 below.

FIG. 3 is a block diagram shows an example system that can perform model similarity comparisons to verify data removal in machine learning models. The example system 300 of FIG. 3 includes similarly referenced elements from FIG. 2. In addition, the system 300 includes a first set of models S1 302 generated using data samples 204A, 204B, and 204C at training. The system 300 also includes a forgotten model 304. For example, the forgotten model 304 may be generated using a sample forgetter as in FIG. 2. The system 300 further includes a second set of models S2 306 generated using data samples 204B and 204C at training. The system 300 also includes a first distribution of similarity scores sim_diff 308, a second distribution of similarity scores sim1 310, a third distribution of similarity scores sim2 312, and fourth distribution of similarity scores 314, being generated by a model similarity calculator 218.

In the example of FIG. 3, the model similarity calculator 218 may calculate distributions of similarity scores between the forgotten model 304 and various other models. As one example, the forgotten model 304 may have a data sample removed. For example, the data sample may be the data sample 204A. In various examples, a series of machine learning models 302 may be trained using all the data used to train the original model, including data samples 204A, 204B, and 204C. For example, due to various factors and the stochastic nature of the training of the machine learning models, the resulting models 302 may each be slightly different. In addition, a second set of models S2 306 may be similarly trained using data samples 204B and 204C. In various examples, the two sets of models 302 and 306 may be trained using the same architecture and hyperparameters as the original model (not shown) from which the target sample 204A is to be forgotten.

Still referring to FIG. 3, the model similarity calculator 218 may compare the forgotten model 304 with each of the models 302 to generate a first distribution of similarity scores, as indicated by arrow 320. The model similarity calculator 218 can also compare the forgotten model 304 with each of the models 306 to generate a second distribution of similarity scores, as indicated by arrow 322. For example, the model similarity calculator 218 may compute the pairwise similarity between the forgotten model 304 and each of the models in both sets of models 302 and models 306, resulting in distributions of similarity scores sim1 310 and sim2 312, respectively. In some examples, the distributions of similarity scores may be in the form of vectors of similarity scores. The number of similarity scores in each vector may depend on the number of models trained in the first set of models 302 and the second set of models 306. For example, the more models trained in the first set of models 302 and the second set of models 306, the greater number of similarity scores in each vector and the greater the confidence of the resulting verification. In some examples, these two computed vectors of similarities sim1 310 and sim2 312 can then be compared to determine if the forgetting succeeded, as described in greater detail below.

The model similarity calculator 218 may also compute a pairwise similarity between each model in S2 306 and each model in S1 302, as indicated by arrow 316. This comparison 316 may result in the distribution of similarity scores sim_diff 308. For example, the pairwise similarities may be computed using any suitable model similarity metric. In some examples, the pairwise similarities may be computed using a similarity index that measures the relationship between representational similarity matrices. For example, the similarity index may be calculated using centered kernel alignment. In various examples, the model similarity calculator 218 may also compute the pairwise similarity between all the models in the set of models 306, as indicated by an arrow 318. This comparison 318 may result in the distribution of similarity scores sim_same 314.

In various examples, a distribution difference calculator (not shown) can calculate differences between the distributions of similarity scores to determine whether two of the distributions of similarity scores are similar distributions 222 or different distributions 224. The calculation of the differences between the distributions may be performed using any suitable technique. For example, the significance of the difference between two distributions can be measured using any suitable techniques, such as a t-test, the Kolmogorov-Smirnov (K-S) test, or Kullback-Liebler (KL) divergence. In various examples, other means of measuring the difference may include using the Z-test, Mann-Whitney-Wilcoxon test, or trimmed means. For example, the distributions sim1 310 and sim2 312 can be compared using KL divergence to calculate a difference KL(sim1∥sim2) of the two distributions sim1 310 and sim2 312. Similarly, in various examples, the distributions sim_diff 308 and sim_same 314 may be compared with sim1 310 to calculate the differences KL(sim1∥sim_diff) and KL(sim111 sim_same). Likewise, and the distributions sim_diff 308 and sim_same 314 may be compared with sim2 312 to calculate the differences KL(sim2∥sim_diff) and KL(sim2∥sim_same).

In various examples, the resulting differences can be compared to each other or to a threshold to determine if the forgetting succeeded. In some examples, a successful forgetting of the target data sample 204A may be detected in response to determining that a difference exceeds a threshold. For example, a successful forgetting of the target data sample 204A may be detected in response to detecting that the KL divergence value KL(sim1∥sim2) exceeds a difference threshold. Otherwise, a failed forgetting of the target data sample 204A may be detected in response to determining that the KL divergence value does not exceed the difference threshold. In some examples, a successful forgetting of the target data sample 204A may be detected in response to determining that a difference does not exceed a threshold. For example, successful forgetting of the target data sample 204A may be detected in response to detecting that the KL divergence value KL(sim2∥sim_same) does not exceed the difference threshold. Otherwise, a failed forgetting of the target data sample 204A may be detected in response to detecting that the KL divergence value exceeds the threshold. Alternatively, or in addition, in various examples, if KL(sim2∥sim_same)<KL(sim2∥sim_diff), then the removed sample may be detected as having been successfully been forgotten. In other words, if the distribution of similarity scores between the forgotten model 304 and the models 306 trained without the sample is much closer to the distribution of similarity scores between the models 306 trained without the sample than to the distribution of scores when comparing models between sets. Similarly, alternatively or in addition, if KL(sim1∥sim_diff)<KL(sim1∥sim_same), then the removed sample may also be detected as having been successfully forgotten. Otherwise, the removed sample may be detected as being unsuccessfully forgotten because its information remains within the forgotten model 304.

It is to be understood that the block diagram of FIG. 3 is not intended to indicate that the system 300 is to include all of the components shown in FIG. 3. Rather, the system 300 can include fewer or additional components not illustrated in FIG. 3 (e.g., additional forgotten samples, similarity calculations, or additional models, etc.).

FIG. 4 is a block diagram shows an example system for verifying data removal in machine learning models using model uncertainty. The example system 400 of FIG. 4 includes similarly referenced elements from FIG. 2. The example system 400 of FIG. 4 further includes a model uncertainty calculator 402 shown receiving a retrained model 404, a forgotten model 406, and a target data sample 204A. The model uncertainty calculator 402 is also shown generating model uncertainties 408. The example system 400 further includes an uncertainty similarity calculator 410 that receives calculated model uncertainties 408 and outputs detection of a different uncertainties 412 or a similar uncertainties 414.

In the example of FIG. 4, the system 400 may compare the behavior of a forgotten model 406 to the behavior of a retrained model 404 that is trained on a subset of training data that excludes data sample 204A that was to be forgotten from the forgotten model 406. In system 400, the model uncertainty calculator 402 calculates various model uncertainties 408. For example, model uncertainties 408 may be calculated with respect to specific samples, which may include target data samples 210 as well as samples, such as samples 204B and 204C, known not to be not forgotten. In some examples, the uncertainty score may be only generated for data samples, such as data sample 204A, that were to be forgotten. In various examples, each sample may be processed using a model and an uncertainty score generated for each sample that the respective model processes.

Still referring to FIG. 4, in various examples, any suitable model uncertainty methods may be used to compute model uncertainties 408 indicating how certain the original model 208 or the retrained model 404 and the forgotten model 406 are of their prediction for a target sample 204A. For example, the model uncertainty calculator 402 may use Bayesian networks, Monte Carlo (MC) dropout, prior networks, or deep ensembles, among other suitable techniques. As one example, the MC dropout method may be used to determine a dropout rate and apply a dropout during the testing phase, applying each model to each sample X times. During each of the X iterations, a different random dropout is applied in the target model according to the chosen rate and the prediction of the model for target sample 204A is recorded. Each of the X times, a possibly different prediction is output from the target model. Then, different measures can be applied to the X prediction vectors to determine the level of uncertainty of the target model. For example, the different measures may include the number of times the maximum predicted value was output, or the amount of entropy between the different predictions. In the case of a regression task, the width of the prediction range can also be used as a different measure.

In various examples, the uncertainty similarity calculator 410 may compare the model uncertainties 408 to determine whether the model uncertainties 408 are different uncertainties 412 or similar uncertainties 414. For example, the uncertainty similarity calculator 410 may compare the model uncertainty 408 of the retrained model with respect to the target data sample 210 with the model uncertainty of the forgotten model 406 with respect to the target data sample. In some examples, the target data sample 210 may be verified as having been forgotten in response to detecting that the model uncertainties 408 are similar uncertainties 414. By contrast, the uncertainty of the forgotten model 406 with respect to the data sample 204A will likely, but not necessarily, be different from the uncertainty of the trained model 208 with respect to the data sample 204A, or any other model trained using training data that includes the data sample 204A. Such a different model uncertainty 412 may also be used in determination of the uncertainty threshold. In some examples, the uncertainty similarity calculator 410 may compare the model uncertainty 408 of the forgotten model 406 with respect to a sample known to be not forgotten and the model uncertainty 408 of the forgotten model with respect to the target data samples 210. Thus, in various examples, different model uncertainties 412 may be detected and used for verification.

It is to be understood that the block diagram of FIG. 4 is not intended to indicate that the system 400 is to include all of the components shown in FIG. 4. Rather, the system 400 can include fewer or additional components not illustrated in FIG. 4 (e.g., additional target data samples, users, data samples, or models, etc.). For example, the model uncertainty calculator 402 can alternatively calculate uncertainty of the forgotten model 406 with respect to the target data samples 210 and an uncertainty of the forgotten model 406 with respect to a data sample that is known to be excluded from training the forgotten model 406. In this example, a successful removal of the data sample 202A from the forgotten model 406 can be verified in response to detecting similar uncertainties for the different samples. As one technical benefit of such alternative, such an uncertainty comparison may be used as an online evaluation method with less resource usage compared with the other methods. For example, an online evaluation can be run every time a sample or group of samples is forgotten.

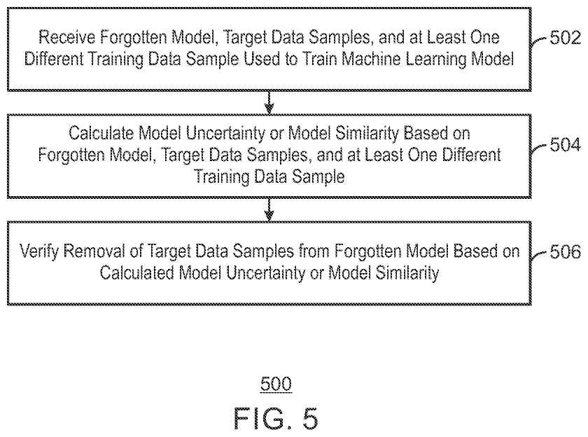

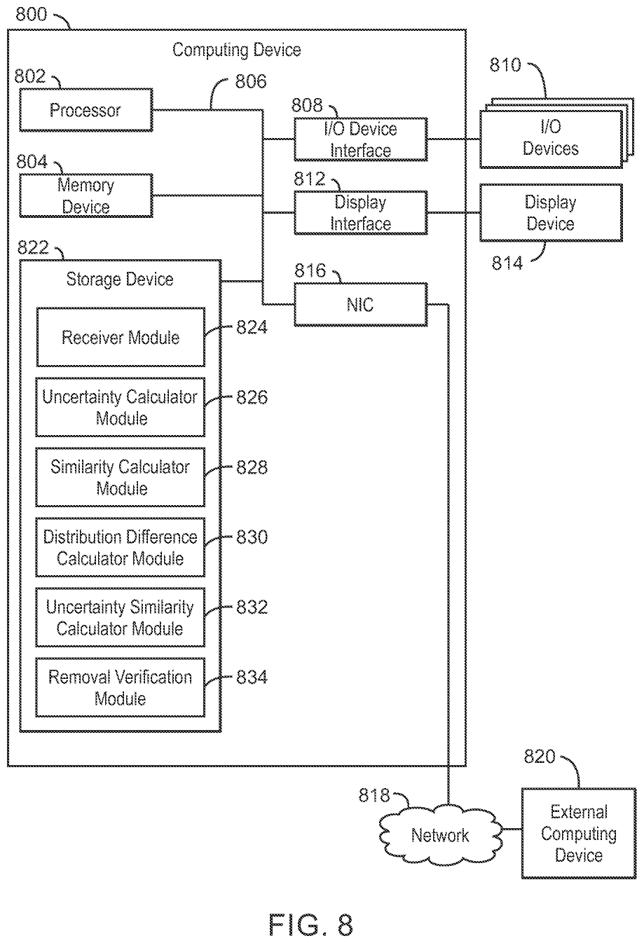

FIG. 5 is a process flow diagram of an example method that can verify data removal in machine learning models. The method 500 can be implemented with any suitable computing device, such as the computing device 800 of FIG. 8 and is described with reference to the system 100 of FIG. 1. For example, the methods described below can be implemented using the processor 802 of FIG. 8.

At block 502, a forgotten model, target data samples, and at least one different training data sample used to train a machine learning model are received. For example, the target data sample may be a data sample used to train the machine learning model that is to be verified as removed from the forgotten model. The at least one different training data sample may be a different data sample than the target data samples.

At block 504, a model uncertainty or a model similarity is calculated based on the forgotten model, the target data samples, and the at least one different training data sample. In some examples, the model uncertainty or model similarity may be calculated using a retrained model based on the machine learning model as trained without the target data sample. In various examples, the model similarity may be calculated using the method 600 of FIG. 6. For example, a first set of models may be trained on the training data samples and the target data sample and a second set of models may be trained on the training data samples without the target data sample. A similarity may be computed between the forgotten model and the first set of models to generate a first distribution of similarity scores, and a similarity may be computed between the forgotten model and the second set of models to generate a second distribution of similarity scores. In some examples, a similarity may be computed between the first set of models and the second set of models to generate a third distribution of similarity scores, and a similarity may be computed between the second set of models to generate a fourth distribution of similarity scores. In various examples, a set of models may be trained on the training data sample without the target data sample and the first distribution of similarity scores computed between the forgotten model and a set of retrained models, and the fourth distribution of similarity scores may be computed between the set of retrained models. In some examples, the model uncertainty may be calculated using the method 700 of FIG. 7. For example, an uncertainty of the forgotten model may be calculated with respect to the target data sample to be forgotten and an uncertainty of a retrained model trained with the target data sample absent from the training set used to train the forgotten model may be calculated with respect to the target data sample to be forgotten. In some examples, an uncertainty of the forgotten model may be calculated with respect to the target data sample to be forgotten and a sample known to be absent from the training set used to train the forgotten model. Alternatively, the uncertainty of the forgotten model may be calculated with respect to the target data sample to be forgotten and the calculated uncertainty compared to an uncertainty threshold. For example, the uncertainty threshold may be calculated based on an uncertainty of a retrained model trained with the target data sample absent from the training set with respect to the target data sample, and an uncertainty of the machine learning model with respect to the target data sample to be forgotten. In various examples, both a model uncertainty and a model similarity is calculated.

At block 506, a removal of the target data samples from the forgotten model is verified based on the model similarity or the model uncertainty. For example, the removal of the target data samples may be verified in response to detecting that a similarity of the forgotten model with a first set of models trained with the target data sample is less than the similarity of the forgotten model with a second set of models trained without the target data samples. In some examples, the removal of the target data samples may be verified based on the analysis of calculated differences of distributions as described in FIG. 6. For example, a comparison may be performed between the first distribution of similarity scores and the second distribution of similarity scores, and the removal of the target data sample may be verified as having succeeded in response to detecting that a difference of distributions between the first distribution of similarity scores and the second distribution of similarity scores exceeds a threshold. In some examples, the removal of the target data sample may be verified as having succeeded in response to detecting that a difference of distributions calculated between the second distribution and the fourth distribution is less than a difference of distributions calculated between the second distribution and the third distribution, or in response to detecting that a difference of distributions calculated between the first distribution and the fourth distribution is greater than a difference of distributions calculated between the first distribution and the third distribution. In various examples, the removal of the target data sample may be verified as having succeeded in response to detecting that a difference of distributions calculated between the first distribution of similarity scores and the fourth distribution of similarity scores does not exceed a threshold. In various examples, the removal of the target data samples may be verified in response to detecting that an uncertainty of the forgotten model with respect to the target data sample is similar to the uncertainty of a retrained model trained without the target data samples. In some examples, the removal of the target data sample may be verified as having succeeded in response to detecting that the uncertainty of the target data sample is similar to the uncertainty of the sample known to be absent. In various examples, a removal of the target data samples from the forgotten model can be verified based on both the model similarity and the model uncertainty. One potential technical benefit of using both the model similarity and the model uncertainty is increased accuracy of the verification.

The process flow diagram of FIG. 5 is not intended to indicate that the operations of the method 500 are to be executed in any particular order, or that all of the operations of the method 500 are to be included in every case. Additionally, the method 500 can include any suitable number of additional operations.

FIG. 6 is a process flow diagram of an example method that can verify data removal in machine learning models using model similarity. The method 600 can be implemented with any suitable computing device, such as the computing device 800 of FIG. 8 and is described with reference to the system 200 of FIG. 2 and the system 300 of FIG. 3. For example, the methods described below can be implemented using the processor 802 of FIG. 8.

At block 602, a machine learning model, a forgotten model, and one or more target data samples are received. For example, the one or more target data samples may have been used to train the machine learning model. In some examples, the architecture and hyperparameters of the machine learning model may be received instead of the machine learning model.

At block 604, two sets of models are trained using a same architecture and hyperparameters as the machine learning model with a first set of models trained on a training set including the target data samples and a second set of models trained on the training set without the target data samples. For example, the stochastic nature of machine model training may result in a set of slightly different models in both the first set of models and the second set of models.

At block 606, a pairwise similarity Sim_Same is calculated between all models in the second set of models and a pairwise similarity Sim_Diff is calculated between each model in the first set of models and the second set of models. For example, each pairwise similarity may result in a distribution of similarity scores that may take the form of a vector of similarity scores.

At block 608, a pairwise similarity Sim1 is calculated between the forgotten model and each of the first set of models, and a pairwise similarity Sim2 is calculated between the forgotten model and each of the models in the second set of models. For example, each pairwise similarity may result in a distribution of similarity scores that may take the form of a vector of similarity scores.

At block 610, a difference of distributions is calculated between similarity Sim1 and similarity Sim2. In various examples, the difference may be calculated using a t-test, the Kolmogorov-Smirnov (K-S) test, or Kullback-Liebler (KL) divergence. For example, the difference may be calculated as KL(Sim1∥Sim2).

At block 612, a difference of distributions is calculated between similarity Sim1 and similarity Sim_Same, and between similarity Sim1 and similarity Sim_Diff. In various examples, the difference may be calculated using a t-test, the Kolmogorov-Smirnov (K-S) test, or Kullback-Liebler (KL) divergence. For example, the differences may be calculated as KL(Sim1∥Sim_Same) and KL(Sim1∥Sim_Diff).

At block 614, a difference of distributions is calculated between similarity Sim2 and similarity Sim_Same, and between similarity Sim2 and similarity Sim_Diff. In various examples, the difference may be calculated using a t-test, the Kolmogorov-Smirnov (K-S) test, or Kullback-Liebler (KL) divergence. For example, the differences may be calculated as KL(Sim2∥Sim_Same) and KL(Sim2∥Sim_Diff).

At block 616, the difference of distributions are analyzed to verify a removal of the target data samples from the forgotten model. In some examples, the difference of distributions at block 610 may be compared to a difference threshold to verify removal of the target data samples. For example, the removal of the target data samples may be verified in response to detecting that the difference threshold is exceeded by the value KL(Sim1∥Sim2). In some examples, the removal of the target data samples may be verified in response to detecting that the difference threshold is not exceeded by the value KL(sim2∥sim_same). In various examples, two or more difference of distributions may be compared. In some examples, other comparisons may alternatively or additionally be made to confirm removal of the target data samples. For example, if KL(sim2∥sim_same)<KL(sim2∥sim_diff), then the removed sample may be detected as having been successfully been forgotten. Similarly, in various examples, if KL(sim1∥sim_diff)<KL(sim1∥sim_same), then the removed sample may also be detected as having been successfully forgotten.

The process flow diagram of FIG. 6 is not intended to indicate that the operations of the method 600 are to be executed in any particular order, or that all of the operations of the method 600 are to be included in every case. Additionally, the method 600 can include any suitable number of additional operations.

FIG. 7 is a process flow diagram of an example method that can verify data removal in machine learning models using model uncertainty. The method 700 can be implemented with any suitable computing device, such as the computing device 800 of FIG. 8 and is described with reference to the system 400 of FIG. 4. For example, the methods described below can be implemented using the processor 802 of FIG. 8.

At block 702, a machine learning model, a forgotten model, target data samples, and one or more different training data samples are received. For example, the one or more target data samples may have been used to train the machine learning model.

At block 704, the machine learning model is retrained on training data without the target data samples to generate a retrained model. For example, the retrained model may be trained on the one or more different training data samples using the same architecture and hyperparameters as used to train the machine learning model.

At block 706, an uncertainty of the forgotten model with respect to the target data samples and an uncertainty of a retrained model with respect to the target data samples are calculated. In various examples, the uncertainty may be calculated using Bayesian networks, Monte Carlo (MC) dropout, prior networks, or deep ensembles.

At block 708, an uncertainty of the forgotten model is compared with the uncertainty of the retrained model to verify removal of the target data samples from the forgotten model. For example, the successful removal of the target data samples may be verified in response to detecting that the uncertainty of the forgotten model is similar to the uncertainty of the retrained model.

The process flow diagram of FIG. 7 is not intended to indicate that the operations of the method 700 are to be executed in any particular order, or that all of the operations of the method 700 are to be included in every case. Additionally, the method 700 can include any suitable number of additional operations.

In some scenarios, the techniques described herein may be implemented in a cloud computing environment. As discussed in more detail below in reference to at least FIGS. 8-11 a computing device configured to verify removal of data may be implemented in a cloud computing environment. It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

FIG. 8 is block diagram of an example computing device that can verify data removal in machine learning models. The computing device 800 may be for example, a server, desktop computer, laptop computer, tablet computer, or smartphone. In some examples, computing device 800 may be a cloud computing node. Computing device 800 may be described in the general context of computer system executable instructions, such as program modules, being executed by a computer system. Generally, program modules may include routines, programs, objects, components, logic, data structures, and so on that perform particular tasks or implement particular abstract data types. Computing device 800 may be practiced in distributed cloud computing environments where tasks are performed by remote processing devices that are linked through a communications network. In a distributed cloud computing environment, program modules may be located in both local and remote computer system storage media including memory storage devices.

The computing device 800 may include a processor 802 that is to execute stored instructions, a memory device 804 to provide temporary memory space for operations of said instructions during operation. The processor can be a single-core processor, multi-core processor, computing cluster, or any number of other configurations. The memory 804 can include random access memory (RAM), read only memory, flash memory, or any other suitable memory systems.

The processor 802 may be connected through a system interconnect 806 (e.g., PCI®, PCI-Express®, etc.) to an input/output (I/O) device interface 808 adapted to connect the computing device 800 to one or more I/O devices 810. The I/O devices 810 may include, for example, a keyboard and a pointing device, wherein the pointing device may include a touchpad or a touchscreen, among others. The I/O devices 810 may be built-in components of the computing device 800, or may be devices that are externally connected to the computing device 800.

The processor 802 may also be linked through the system interconnect 806 to a display interface 812 adapted to connect the computing device 800 to a display device 814. The display device 814 may include a display screen that is a built-in component of the computing device 800. The display device 814 may also include a computer monitor, television, or projector, among others, that is externally connected to the computing device 800. In addition, a network interface controller (NIC) 816 may be adapted to connect the computing device 800 through the system interconnect 806 to the network 818. In some embodiments, the NIC 816 can transmit data using any suitable interface or protocol, such as the internet small computer system interface, among others. The network 818 may be a cellular network, a radio network, a wide area network (WAN), a local area network (LAN), or the Internet, among others. An external computing device 820 may connect to the computing device 800 through the network 818. In some examples, external computing device 820 may be an external webserver 820. In some examples, external computing device 820 may be a cloud computing node.

The processor 802 may also be linked through the system interconnect 806 to a storage device 822 that can include a hard drive, an optical drive, a USB flash drive, an array of drives, or any combinations thereof. In some examples, the storage device may include a receiver module 824, an uncertainty calculator module 826, a similarity calculator module 828, a distribution difference calculator module 830, an uncertainty similarity calculator module 832, and a removal verification module 834. The receiver module 824 can receive one or more target data samples from a training set used to train a machine learning model, a training data sample that includes at least one different data sample from the training set, and a forgotten model that may be the machine learning model with a forgetting mechanism applied on the one or more target data samples. In some examples, the one or more target data samples include one or more of a number of data samples from the training set to be verified as forgotten from the machine learning model. The uncertainty calculator module 826 can calculate a model uncertainty based on the forgotten model, the one or more target data samples, and the training data sample. For example, the uncertainty calculator module 826 can calculate an uncertainty of the forgotten model with respect to the target data sample to be forgotten and an uncertainty of a retrained model based on the machine learning model retrained with the data sample absent from the training set used to train the forgotten model with respect to the target data sample to be forgotten. In some examples, the uncertainty calculator module 826 can calculate an uncertainty of the forgotten model with respect to the one or more target data samples to be forgotten and a sample known to be absent from the training set used to train the forgotten model. The similarity calculator module 828 can calculate a model similarity based on the forgotten model, the one or more target data samples, and the training data sample. In some examples, the similarity calculator module 828 can train a first set of models on the training data including the one or more target data samples and a second set of models on the training data without the one or more target data samples. The similarity calculator module 828 can then perform a comparison of the forgotten model with the first set of models and the second set of models to generate a first distribution of similarity scores and a second distribution of similarity scores. In some examples, the similarity calculator module 828 can perform a comparison between the first set of models and the second set of models, and compute a pairwise similarity between all models in the second set of models. For example, the similarity calculator module 828 can compute a similarity between the first set of models and the second set of models to generate a third distribution of similarity scores, and a similarity between the second set of models to generate a fourth distribution of similarity scores. A distribution difference calculator module 830 can perform a comparison between a first distribution of similarity scores and a second distribution of similarity scores. For example, the distribution difference calculator module 830 can calculate a difference of distributions between two of any of the distributions of similarity scores calculated by the similarity calculator module 828. An uncertainty similarity calculator module 832 can calculate an uncertainty similarity between the uncertainties calculated by the uncertainty calculator module 828. For example, the uncertainty similarity calculator module 832 may include code to calculate an uncertainty similarity between the uncertainty of the forgotten model with respect to the target data sample and the uncertainty of the retrained model with respect to the target data sample. In some examples, the uncertainty similarity calculator module 832 may include code to calculate an uncertainty similarity between the uncertainty of the forgotten model with respect to the target data sample and an uncertainty of the forgotten model with respect to a data sample that is known to be excluded from training the forgotten model. The removal verification module 834 can verify a removal of the one or more target data samples from the forgotten model based on the model similarity or the model uncertainty. For example, the removal verification module 834 can verify that the removal of the target data sample succeeded in response to detecting that a difference of distributions between the first distribution of similarity scores and the second distribution of similarity scores exceeds a threshold. In some examples, the removal verification module 834 can verify that the removal of the target data samples succeeded in response to detecting that a difference of distributions calculated between the second distribution and the fourth distribution is less than a difference of distributions calculated between the second distribution and the third distribution, or in response to detecting that a difference of distributions calculated between the first distribution and the fourth distribution is greater than a difference of distributions calculated between the first distribution and the third distribution. In various examples, the removal verification module 834 can verify that the removal of the target data samples succeeded in response to detecting that a difference of distributions calculated between the second distribution of similarity scores and the fourth distribution of similarity scores does not exceed a threshold. In some examples, the removal verification module 834 may include code to verify that the removal of the target data sample succeeded in response to detecting that an uncertainty of the forgotten model is similar to the uncertainty of a retrained model. In various examples, the removal verification module 834 may include code to verify that the removal of the target data sample succeeded in response to detecting that an uncertainty of the forgotten model with respect to the sample known to be not forgotten is different than the forgotten model with respect to the target data samples. In some examples, the removal verification module 834 includes code to execute a sanity check using a comparison to a result of forgetting a different data sample.

It is to be understood that the block diagram of FIG. 8 is not intended to indicate that the computing device 800 is to include all of the components shown in FIG. 8. Rather, the computing device 800 can include fewer or additional components not illustrated in FIG. 8 (e.g., additional memory components, embedded controllers, modules, additional network interfaces, etc.). For example, either the uncertainty calculator module 826 or the similarity calculator module 828 may be excluded in various examples. Furthermore, any of the functionalities of the receiver module 824, the uncertainty calculator module 826, the similarity calculator module 828, the distribution difference calculator module 830, the uncertainty similarity calculator module 832, and the removal verification module 834 may be partially, or entirely, implemented in hardware and/or in the processor 802. For example, the functionality may be implemented with an application specific integrated circuit, logic implemented in an embedded controller, or in logic implemented in the processor 802, among others. In some embodiments, the functionalities of the receiver module 824, the uncertainty calculator module 826, the similarity calculator module 828, the distribution difference calculator module 830, the uncertainty similarity calculator module 832, or the removal verification module 834 can be implemented with logic, wherein the logic, as referred to herein, can include any suitable hardware (e.g., a processor, among others), software (e.g., an application, among others), firmware, or any suitable combination of hardware, software, and firmware.

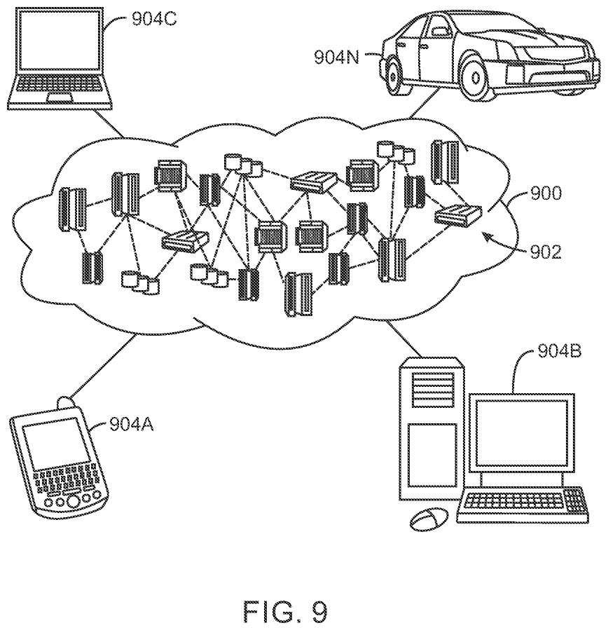

Referring now to FIG. 9, illustrative cloud computing environment 900 is depicted. As shown, cloud computing environment 900 comprises one or more cloud computing nodes 902 with which local computing devices used by cloud consumers, such as, for example, personal digital assistant (PDA) or cellular telephone 904A, desktop computer 904B, laptop computer 904C, and/or automobile computer system 906N may communicate. Nodes 902 may communicate with one another. They may be grouped (not shown) physically or virtually, in one or more networks, such as Private, Community, Public, or Hybrid clouds as described hereinabove, or a combination thereof. This allows cloud computing environment 900 to offer infrastructure, platforms and/or software as services for which a cloud consumer does not need to maintain resources on a local computing device. It is understood that the types of computing devices 904A-N shown in FIG. 9 are intended to be illustrative only and that computing nodes 902 and cloud computing environment 900 can communicate with any type of computerized device over any type of network and/or network addressable connection (e.g., using a web browser).

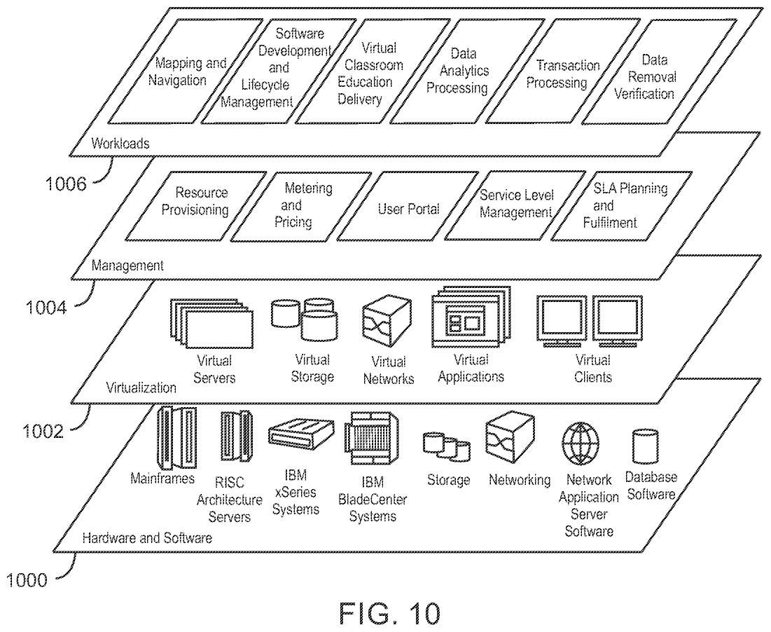

Referring now to FIG. 10, a set of functional abstraction layers provided by cloud computing environment 900 (FIG. 9) is shown. It should be understood in advance that the components, layers, and functions shown in FIG. 10 are intended to be illustrative only and embodiments of the invention are not limited thereto. As depicted, the following layers and corresponding functions are provided.

Hardware and software layer 1000 includes hardware and software components. Examples of hardware components include: mainframes; RISC (Reduced Instruction Set Computer) architecture based servers; servers; blade servers; storage devices; and networks and networking components. In some embodiments, software components include network application server software and database software.

Virtualization layer 1002 provides an abstraction layer from which the following examples of virtual entities may be provided: virtual servers; virtual storage; virtual networks, including virtual private networks; virtual applications and operating systems; and virtual clients. In one example, management layer 1004 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1006 provides examples of functionality for which the cloud computing environment may be utilized. Examples of workloads and functions which may be provided from this layer include: mapping and navigation; software development and lifecycle management; virtual classroom education delivery; data analytics processing; transaction processing; and data removal verification.

The present invention may be a system, a method and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the techniques. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

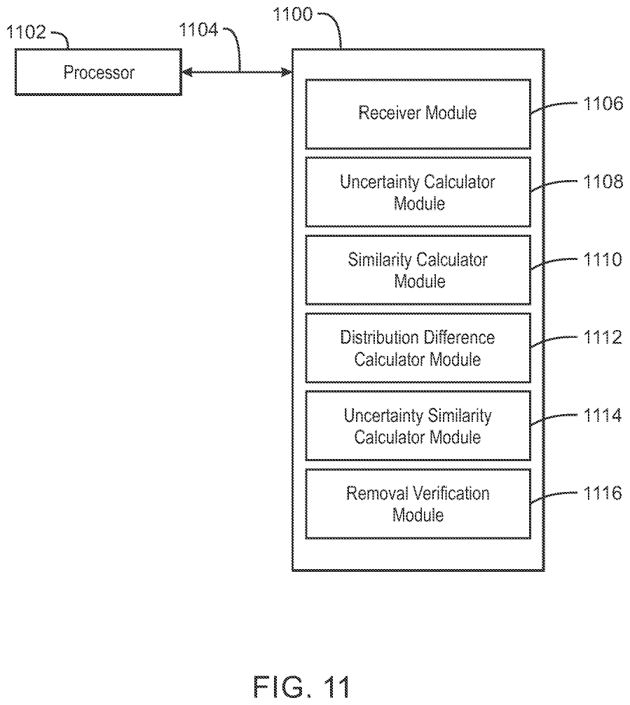

Referring now to FIG. 11, a block diagram is depicted of an example tangible, non-transitory computer-readable medium 1100 that can verify data removal in machine learning models. The tangible, non-transitory, computer-readable medium 1100 may be accessed by a processor 1102 over a computer interconnect 1104. Furthermore, the tangible, non-transitory, computer-readable medium 1100 may include code to direct the processor 1102 to perform the operations of the methods 500-700 of FIGS. 5-7.

The various software components discussed herein may be stored on the tangible, non-transitory, computer-readable medium 1100, as indicated in FIG. 11. For example, a receiver module 1106 includes code to receive a machine learning model, a forgotten model, and one or more target data samples. For example, the one or more target data samples may be identified in a request to be forgotten. An uncertainty calculator module 1108 includes code to calculate a model uncertainty based on the machine learning model, the forgotten model, and the target data sample. In various examples, the uncertainty calculator module 1108 includes code to calculate an uncertainty of the forgotten model with respect to a target data sample and an uncertainty of a retrained model with respect to a target data sample. For example, the retrained model may be trained without the target data sample. In some examples, the uncertainty calculator module 1108 includes code to calculate an uncertainty of the forgotten model with respect to the target data sample and an uncertainty of the forgotten model with respect to a data sample that is known to be excluded from training the forgotten model. A similarity calculator module 1110 includes code to calculate a model similarity based on the machine learning model, the forgotten model, and the target data sample. The similarity calculator module 1110 also includes code to train two sets of models using a same architecture and hyperparameters as the machine learning model. For example, a first set of models is trained on a training set including the target data sample and the second set of models is trained on the training set without the target data sample. In some examples, the similarity calculator module 1110 also includes code to calculate a pairwise similarity between all models in the second set of models. In various examples, the similarity calculator module 1110 also includes code to calculate a pairwise similarity between the forgotten model and the first set of models, and between the forgotten model and the second set of models. A distribution difference calculator module 1112 may have code to perform a comparison between a first distribution of similarity scores and a second distribution of similarity scores. For example, the distribution difference calculator module 1112 may have code to calculate a difference of distributions between two of any of the distributions of similarity scores calculated by the similarity calculator module 1110. An uncertainty similarity calculator module 1114 may include code to calculate an uncertainty similarity between the uncertainties calculated by the uncertainty calculator module 1108. For example, the uncertainty similarity calculator module 1114 may include code to calculate an uncertainty similarity between the uncertainty of the forgotten model with respect to the target data sample and the uncertainty of the retrained model with respect to the target data sample. In some examples, the uncertainty similarity calculator module 1114 may include code to calculate an uncertainty similarity between the uncertainty of the forgotten model with respect to the target data sample and an uncertainty of the forgotten model with respect to a data sample that is known to be excluded from training the forgotten model. A removal verification module 1116 includes code to verify removal of the target data sample from the forgotten model based on the model similarity or the model uncertainty. For example, the removal verification module 1116 may include code to verify that the removal of the target data sample succeeded in response to detecting that a difference of distributions between the first distribution of similarity scores and the second distribution of similarity scores exceeds a threshold. In some examples, the removal verification module 1116 may include code to verify that the removal of the target data samples succeeded in response to detecting that a difference of distributions calculated between the second distribution and the fourth distribution is less than a difference of distributions calculated between the second distribution and the third distribution, or in response to detecting that a difference of distributions calculated between the first distribution and the fourth distribution is greater than a difference of distributions calculated between the first distribution and the third distribution. In various examples, the removal verification module 1116 may include code to verify that the removal of the target data samples succeeded in response to detecting that a difference of distributions calculated between the second distribution of similarity scores and the fourth distribution of similarity scores exceeds a threshold. In some examples, the removal verification module 1116 may include code to verify that the removal of the target data sample succeeded in response to detecting that an uncertainty of the forgotten model is similar to the uncertainty of a retrained model. In various examples, the removal verification module 1116 may include code to verify that the removal of the target data sample succeeded in response to detecting that an uncertainty of the forgotten model with respect to the sample known to be not forgotten is different than the forgotten model with respect to the target data samples. In some examples, the removal verification module 1116 includes code to execute a sanity check using a comparison to a result of forgetting a different data sample.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It is to be understood that any number of additional software components not shown in FIG. 11 may be included within the tangible, non-transitory, computer-readable medium 1100, depending on the specific application.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive a target data sample from a training set used to train a machine learning model, a training data sample comprising at least one different data sample from the training set, and a forgotten model comprising the machine learning model with a forgetting mechanism applied on the target data sample;
calculate a model uncertainty or a model similarity based on the forgotten model, the target data sample, and the training data sample; and
verify a removal of the target data sample from the forgotten model based on the model similarity or the model uncertainty.

2. The system of claim 1, wherein, to calculate the model similarity, the processor is to train a first set of models on the training data samples and the target data sample and a second set of models on the training data samples without the target data sample, and compute a similarity between the forgotten model and the first set of models to generate a first distribution of similarity scores, and a similarity between the forgotten model and the second set of models to generate a second distribution of similarity scores.

3. The system of claim 2, wherein, to verify the removal of the target data sample based on the model similarity, the processor is to perform a comparison between the first distribution of similarity scores and the second distribution of similarity scores, and verify that the removal of the target data sample succeeded in response to detecting that a difference of distributions between the first distribution of similarity scores and the second distribution of similarity scores exceeds a threshold.

4. The system of claim 2, wherein, to verify the removal of the target data sample based on the model similarity, the processor is to compute a similarity between the first set of models and the second set of models to generate a third distribution of similarity scores, and a similarity between the second set of models to generate a fourth distribution of similarity scores, and verify that the removal of the target data sample succeeded in response to detecting that a difference of distributions calculated between the second distribution and the fourth distribution is less than a difference of distributions calculated between the second distribution and the third distribution, or in response to detecting that a difference of distributions calculated between the first distribution and the fourth distribution is greater than a difference of distributions calculated between the first distribution and the third distribution.

5. The system of claim 1, wherein, to calculate the model similarity, the processor is to train a set of models on the training data sample without the target data sample and compute a first distribution of similarity scores between the forgotten model and a set of retrained models, and a second distribution of similarity scores between the set of retrained models, and verify that the removal of the target data sample succeeded in response to detecting that a difference of distributions calculated between the first distribution of similarity scores and the second distribution of similarity scores does not exceed a threshold.

6. The system of claim 1, wherein, to calculate the model uncertainty, the processor is to calculate an uncertainty of the forgotten model with respect to the target data sample to be forgotten and an uncertainty of a retrained model trained with the target data sample absent from the training set used to train the forgotten model with respect to the target data sample to be forgotten, wherein the processor is to verify that the removal of the target data sample succeeded in response to detecting that the uncertainty of the forgotten model is similar to the uncertainty of the retrained model.

7. The system of claim 1, wherein, to calculate the model uncertainty, the processor is to calculate an uncertainty of the forgotten model with respect to the target data sample to be forgotten and a sample known to be absent from the training set used to train the forgotten model, wherein the processor is to verify that the removal of the target data sample succeeded in response to detecting that the uncertainty of the target data sample is similar to the uncertainty of the sample known to be absent.

8. The system of claim 1, wherein, to calculate the model uncertainty, the processor is to calculate an uncertainty of the forgotten model with respect to the target data sample to be forgotten and compare the calculated uncertainty to an uncertainty threshold, wherein the uncertainty threshold is calculated based on an uncertainty of a retrained model trained with the target data sample absent from the training set with respect to the target data sample, and an uncertainty of the machine learning model with respect to the target data sample to be forgotten.

9. A computer-implemented method, comprising:
receiving, via a processor, a machine learning model, a forgotten model, and a target data sample;
calculating, via the processor, a model uncertainty or a model similarity based on the machine learning model, the forgotten model, and the target data sample; and
verifying, via the processor, a removal of the target data sample from the forgotten model based on the model similarity or the model uncertainty.

10. The computer-implemented method of claim 9, wherein calculating the model similarity comprises training two sets of models using a same architecture and hyperparameters as the machine learning model, wherein a first set of models is trained on a training set including the target data sample and the second set of models is trained on the training set without the target data sample.

11. The computer-implemented method of claim 10, wherein calculating the model similarity comprises calculating a pairwise similarity between all models in the second set of models.

12. The computer-implemented method of claim 10, wherein calculating the model similarity comprises calculating a pairwise similarity between each model in the first set of models and the second set of models.

13. The computer-implemented method of claim 10, wherein calculating the model similarity comprises calculating a pairwise similarity between the forgotten model and the first set of models, and a pairwise similarity between the forgotten model and the second set of models.

14. The computer-implemented method of claim 9, wherein calculating the model uncertainty comprises calculating an uncertainty of the forgotten model with respect to the target data sample and an uncertainty of a retrained model with respect to the target data sample.

15. The computer-implemented method of claim 9, wherein calculating the model uncertainty comprises calculating an uncertainty of the forgotten model with respect to the target data sample and an uncertainty of the forgotten model with respect to a data sample that is known to be excluded from training the forgotten model.

16. The computer-implemented method of claim 9, further comprising executing a sanity check using a comparison to a result of forgetting a different data sample.

17. A computer program product for verification of data removal, the computer program product comprising a computer-readable storage medium having program code embodied therewith, wherein the computer-readable storage medium is not a transitory signal per se, the program code executable by a processor to cause the processor to:
receive a machine learning model, a forgotten model, and a target data sample;
calculate a model uncertainty or a model similarity based on the machine learning model, the forgotten model, and the target data sample; and
verify removal of the target data sample from the forgotten model based on the model similarity or the model uncertainty.

18. The computer program product of claim 17, further comprising program code executable by the processor to train two sets of models using a same architecture and hyperparameters as the machine learning model, wherein a first set of models is trained on a training set including the target data sample and the second set of models is trained on the training set without the target data sample.

19. The computer program product of claim 17, further comprising program code executable by the processor to calculate a pairwise similarity between all models in the second set of models.

20. The computer program product of claim 17, further comprising program code executable by the processor to calculate a pairwise similarity between each model in the first set of models and the second set of models.
